(19) United States
(12) Patent Application Publication
(10) Pub. No.: US 2010/0195956 A1
(43) Pub. Date: Aug. 5, 2010

(54) MULTI-CHANNEL FIBER OPTIC ROTARY JOINT USING DE-ROTATING LENS

(76) Inventors: Boying B. ZHANG, Pennington, NJ (US); Hong Zhang, Pennington, NJ (US)

Correspondence Address: Lu & Associates, P.C., P.O. Box 1380, HAVERTOWN, PA, 19083, US

(21) Appl. No.: 12/646,198

(22) Filed: Dec. 23, 2009

Related U.S. Application Data
(60) Provisional application No. 61/149,139, filed on Feb. 2, 2009.

(51) Int. Cl. G02B 6/42; G02B 6/32

(52) U.S. Cl. 385/26; 385/34

(57) ABSTRACT

A multi-channel fiber optic rotary joint has been invented in which optic signals can be transmitted simultaneously from a rotating fiber optic collimator array and a stationary fiber optic collimator array in air and in other optic fluids. A de-rotating lens, a cylindrical GRIN (Graded Index) lens, is positioned in the path between said rotating fiber optic collimator array and said stationary fiber optic collimator array, and arranged for rotation relative to each fiber optic collimator arrays at a rotary speed equal to one-half the relative rotational rate between said rotating and stationary fiber optic collimator arrays.

### CROSS REFERENCE RELATED APPLICATION

This application claims the benefit of U.S. Provisional Patent Application No. 61/149,139 filed on Feb. 2, 2009.

### BACKGROUND OF THE INVENTION

1. Field of the Invention

The present invention relates generally to the field of apparatus for fiber optic communication, and more particularly, to a multi-channel fiber optic rotary joint using de-rotating GRIN (Graded Index) lens.

2. Description of Related Art

A typical fiber optical rotary joint consists of a fixed fiber collimator holder and a rotatable fiber collimator holder which are relatively rotatable each other to allow uninterrupted transmission of optical signals through the rotational interface from fiber collimators on any one of the holders to the fiber collimators on another holder.

The multi-channel fiber optic rotary joints of prior arts typically utilize an optic de-rotating mechanism between the fixed fiber collimator holder and the rotatable fiber collimator holder. The optic de-rotating mechanism can be Dove prism, Delta prism, Abbe-Konig prism, and Schmidt-Pechan prism, which rotates at half the speed of rotation of the rotatable fiber collimator holder.

The examples of the prior arts include U.S. Pat. No. 4,109,998 (Dove prism), U.S. Pat. No. 4,460,242, U.S. Pat. Nos. 5,271,076 (Dove prism), 7,373,041 (Dove prism & Abbe-Konig prism) and US 2007/0019908 (Schmidt-Pechan prism & Abbe-Konig prism).

U.S. Pat. No. 4,109,998 rotary joint utilizes Dove prism as a de-rotation optic mechanism to de-rotate the images of an input set of optic transmitters located on the rotor, so that they may be focused onto stationary photo detectors located on the stator. De-rotation is accomplished by gearing the rotor and the prism in such a way that the prism rotates half as fast as the rotor. The U.S. Pat. No. 4,109,998 optic rotary joint utilize light emitting diodes (LEDS) or lasers and laser detectors instead of optic fibers. As a result, it does not require the high alignment accuracy required for optic fibers, because the detectors may be quite large. The device is not bidirectional.

U.S. Pat. No. 4,460,242 discloses an optic slip ring employing optical fibers to allow light signals applied to any one or all of a number of inputs to be reproduced at a corresponding number of outputs of the slip ring in a continuous manner. It includes a rotatable output member, a stationary input Member and a second rotatable member which is rotated at half the speed of the output member like a de-rotator. The input member having a plurality of equi-spaced light inputs and the output member having a corresponding number of light outputs and the second rotatable member having a coherent strip formed of a plurality of bundles of optical fibers for transmitting light from the light inputs on the input member to the light outputs.

Most of the prior arts with de-rotating mechanisms can only be used in air because fluids, having similar index of refraction to glass, would render the de-rotating mechanisms, such as a Dove Prism, useless.

### SUMMARY OF THE INVENTION

The object of the present invention is to utilize de-rotating GRIN (Graded Index) lens to realize a multi-channel fiber optic rotary joints which can simultaneously transmit optic signals through a single mechanical rotational interface with a very low-profile which could be used in air and other optic fluids.

### BRIEF DESCRIPTION OF THE DRAWINGS

FIG. 1 is the schematic drawing of de-rotating Dove prism in the prior art;

FIG. 2 is an outline diagram a half-pitch GRIN cylindrical lens in the present invention;

FIG. 3 shows the GRIN lens refractive index profile in X-direction;

FIG. 4 illustrates the principles of a half-pitch GRIN cylindrical lens as a de-rotating mechanism for a multi-channel fiber optic rotary joint in the present invention;

FIG. 5 depicts the position of de-rotating cylindrical GRIN lens relative to a stationary fiber collimator array and a rotary fiber collimator array in the present invention;

FIG. 6 is a cross-sectional view of a multi-channel fiber optic rotary joint in the present invention.

### DETAILED DESCRIPTION OF THE INVENTION

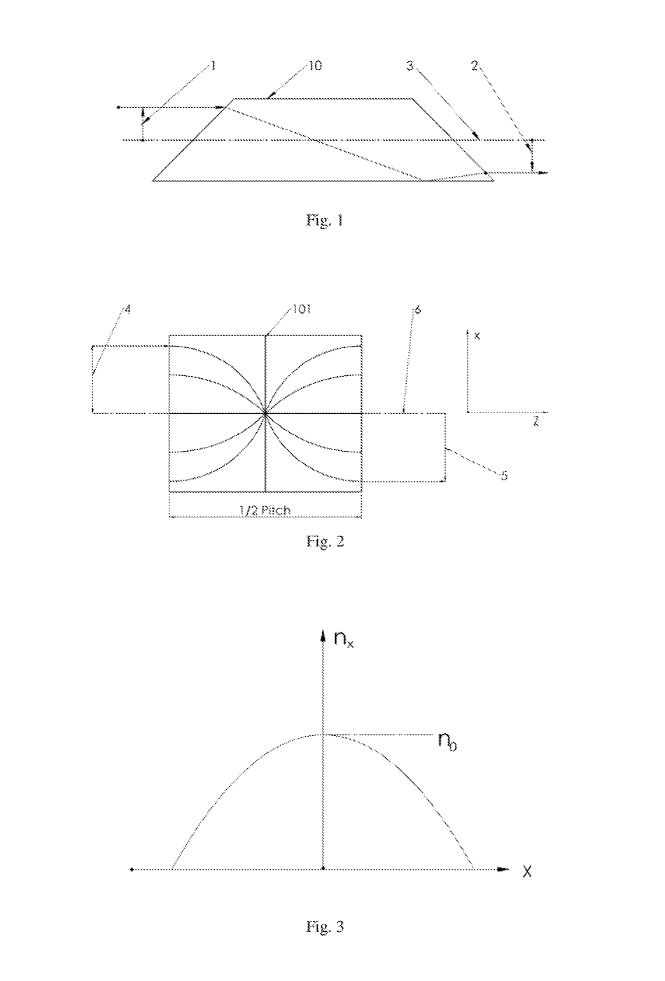

Dove prisms are used to invert an image and when they are rotated along their longitudinal axis, the transmitted image rotates at twice the rate of the prism (FIG. 1.). Therefore, if the prism rotates at half the speed of a rotating object, its image after passing through the prism, will appear to be stationary. FIG. 1 is the schematic drawing of de-rotating Dove prism in the prior art. The image 2 of an object 1 is inverted by the Dove prism 10. Furthermore, if the prism 10 is rotated about the optic axis 3, the image 2 rotates at twice the rate of rotation of Dove prism 10.

GRIN lens are widely used in the fiber optic communication system. One of the most important advantages of GRIN lenses compared to classical lenses is that the optic surfaces of GRIN lenses are flat. In GRIN lens, if the index of refraction of the material is gradually changed along the radial, it is called GRIN rod lenses. If the index of refraction of the material is gradually changed in one direction of the cross section, but remain unchanged in the orthogonal direction the cross section of the lens, it is called GRIN cylindrical lens.

FIG. 2 illustrates imaging principle of a half-pitch GRIN cylindrical lens in the present invention. The length of GRIN lens is measured in Z-direction, e.g., the direction of central line 6.

FIG. 3 illustrates the GRIN lens refractive index profile in X-direction.

$${n}_{x} = {n}_{0} ( 1 - \frac{a}{2} {x}^{2} )$$

In the above equation:

n₀ - - - The axis refractive index of GRIN lens;

x - - - The orthogonal direction of central line 6;

a - - - The constant of the refractive index distribution of the GRIN lens;

nₓ - - - The refractive index of GRIN lens in X axis;

In FIG. 2, the index of refraction of a half-pitch GRIN cylindrical lens 101 is gradually changed in X direction, but remains unchanged in the Y direction (the orthogonal direction of X). The refractive index profile in the X direction is nearly parabolic shape (shown in FIG. 3). The image 5 of an object 4 on the entrance side of a half-pitch GRIN cylindrical lens 101 is inverted to the exit side of the lens in the same way as in FIG. 1, the image of an object on the entrance side of a Dove prism 10 is inverted to the exit side of the Dove prism 10.

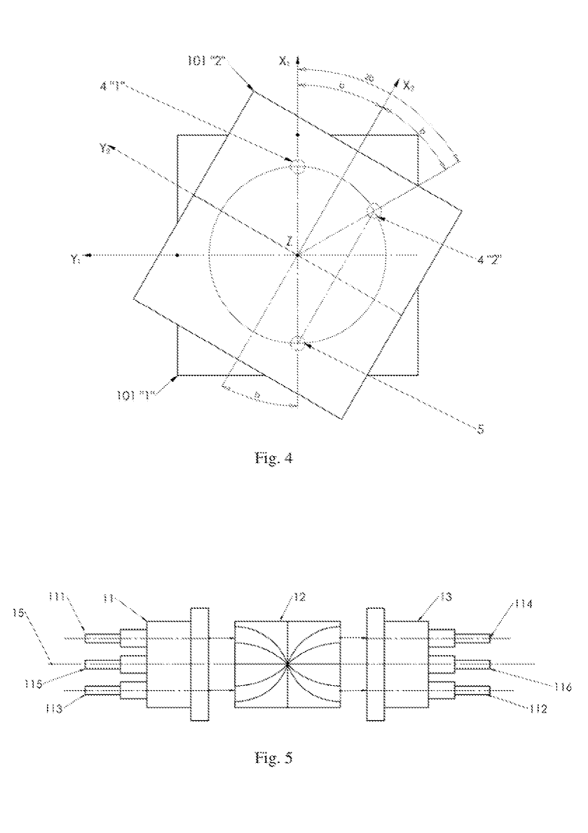

FIG. 4 depicts how the half-pitch GRIN cylindrical lens 101 can be used as a de-rotating mechanism for a multi-channel fiber optic rotary joint in the present invention. As mentioned above, the refractive index profile in the Y-direction remains unchanged. Suppose the GRIN cylindrical lens 101 rotates an angle “b” around its axis “Z” from position “1” to position “2”, e.g., from 101 “1” to 101 “2”. The co-ordinates of the object 4 in position “1”, e.g., 4 “1”, is (X1, Y1). According to FIG. 2, because the image 5 is inverted symmetrically relative to the axis “Z”, the co-ordinates of the image 5 in position “1” are (−X1, Y1). If the object rotates an angle “2b” around axis “Z” in the same direction as the GRIN cylindrical lens 101, the co-ordinates of the object 4 in position “2”, e.g., 4 “2”, are (X2, Y2). It's easy to get that co-ordinates of the image 5 in position “2” are (−X2, Y2). So the absolute position of the image 5 is remaining the same before the rotation and after the rotation. That means that if the half-pitch GRIN cylindrical lens 101 rotates at half the speed of a rotating object 4, its image 5 after passing through the GRIN cylindrical lens 101, will remain to be stationary.

In FIG. 5, a de-rotating cylindrical GRIN lens 12 in the present invention is positioned between a stationary fiber collimator array 13 and a rotary fiber collimator array 11. The said rotary fiber collimator array 11 and said de-rotating cylindrical GRIN lens 12 are rotatable around a common axis 15. All the collimators 111, 112, 113, 114, 115, 116, . . . , in said stationary fiber collimator array 13 and said rotary fiber collimator array 11 are arranged parallel to the common axis 15, and the distance from any of said collimator to said common axis is the same. If the de-rotating GRIN cylindrical lens 12 rotates at half the speed of rotation of said rotary fiber collimator array 11 around axis 15, light signals from the rotary fiber collimator array 11 would be passed through GRIN cylindrical lens 12 and transmitted to the related channel of the stationary fiber collimator array 13 respectively, e.g., the first channel light signal can be transmitted between fiber optic collimator 111 and 112; the second channel light signal can be transmitted between fiber optic collimator 115 and 116; the third channel light signal can be transmitted between fiber optic collimator 113 and 114, so as to provide a continuous, bi-directional, multi-channel optic signal transmission between two fiber optic collimator arrays. Said de-rotating cylindrical GRIN lens 12 can be a half-pitch GRIN cylindrical lens, or a full-pitch GRIN cylindrical lens, or a multiple of half a pitch GRIN cylindrical lens.

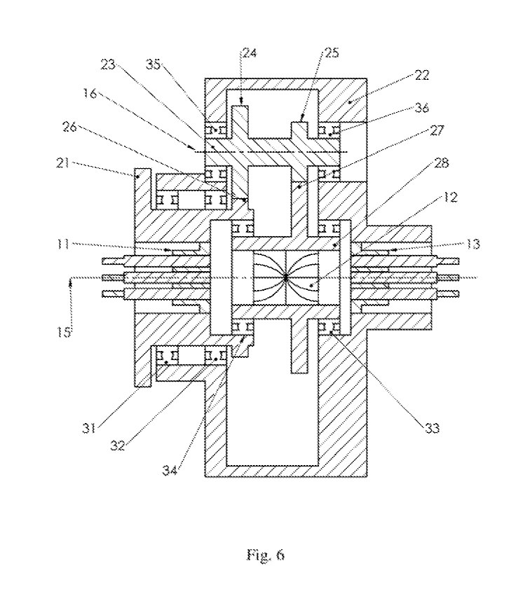

FIG. 6 depicts one of embodiments of a multi-channel fiber optic rotary joint in the present invention. A speed reduction mechanism includes gear 24, 25, 26, and 27, in which gear 26 and 27 are rotatable around said common axis 15, while gear 24 and 25 are rotatable around another parallel axis 16. The gear ratio i from gear 26 to gear 27 can be determined as follows:

$$i = \frac{{Z}_{24} {Z}_{27}}{{Z}_{26} {Z}_{25}}$$

where, Z₂₄, Z₂₅, Z₂₆, Z₂₇ is the gear teeth number of gear 24, 25, 26 and 27 respectively. If the gear ratio i=2:1, that means the gear 27 will rotate at half the speed of the rotation of gear 26.

As illustrated in FIG. 6, said de-rotating cylindrical GRIN lens 12, said stationary fiber collimator array 13 and said rotary fiber collimator array 11 are fixed in the center of cylinder 28, stator 22 and rotor 21 respectively. The relative position between said dc-rotating cylindrical GRIN lens 12, said stationary fiber collimator array 13 and said rotary fiber collimator array 11 are the same as depicted in FIG. 5. Rotor 21 is part of gear 26, which is rotatable relative to stator 22 through bearing 31 and 32. The cylinder 28 is part of gear 27, which is rotatable relative to stator 22 through bearing 32 and 34. Gear 24 and 25 is physically connected the common shaft 23, which is rotatable around axis 16 relative to stator 22 through bearing 35 and 36. As stated above, the gear ratio i=2:1 would assure that de-rotating cylindrical GRIN lens 12 will rotate at half the speed of the rotation of said rotary fiber collimator array 11.

One advantage of the GRIN cylindrical lens over other de-rotating mechanisms is that the optic performance of the GRIN cylindrical lens remained unchanged in air and other optic fluids. In some application under high pressure, e.g., under sea application, the de-rotating mechanism must be used in other optic fluids for the purpose of pressure compensation. Because the positioning of optic elements in fluids with higher optic alignment is much difficult than in air, completion of optic alignment in air and then filling up optic fluid later become a very importance step during fiber optic rotary joint production.

I claim:

1. A multi-channel fiber optic rotary joint for optic signal transmissions comprising:
A first fiber optic collimator array with a rotary axis;
A second fiber optic collimator array with a rotary axis;
Said first fiber optic collimator array and said second fiber optic collimator array are aligned with said rotary axes and relatively rotatable along said rotary axes; and
a de-rotating lens positioned in the path between said first fiber optic collimator array and said second fiber optic collimator array, and arranged for rotation around said rotary axes relative to each of said first and second fiber optic collimator array at a rotary speed equal to one-half the relative rotational rate between said first and second fiber optic collimator array; and a speed reduction mechanism for providing the rotation between said de-rotating lens and said first and second fiber optic collimator array to rotate de-rotating lens at an rotational rate half the rotational rate of between said first and second fiber optic collimator array.

2. For multi-channel fiber optic rotary joint of claim 1, wherein said de-rotating lens is a GRIN cylindrical lens, specifically, with a half-pitch, or a full-pitch, or a multiple of half a pitch.

3. For multi-channel fiber optic rotary joint of claim 2, wherein said de-rotating GRIN cylindrical lens is a cylindrical optic component, in which the index of refraction of the material is gradually changed in one direction of its cross section, but remain unchanged in the orthogonal direction of the cross section of the cylindrical optic component.

4. For multi-channel fiber optic rotary joint of claim 2, wherein said de-rotating GRIN cylindrical lens having unchanged optic performance in air and other optic fluids.

5. For multi-channel fiber optic rotary joint of claim 1, wherein said speed reduction mechanism is a gear mechanism with gear ration of 2:1, or any other passive mechanical system.
